(19) United States
(12) Patent Application Publication
(10) Pub. No.: US 2026/0311687 A1
(43) Pub. Date: Oct. 8, 2026

(54) SPEECH SEPARATION DEVICE

(71) Applicant: mpWAV Inc., Seoul (KR)

(72) Inventors: Hyung Min PARK, Seoul (KR); Ui Hyeop SHIN, Seoul (KR)

(21) Appl. No.: 19/398,572

(22) Filed: Nov. 24, 2025

(30) Foreign Application Priority Data
Apr. 4, 2025 (KR) 10-2025-0043969

(51) Int. Cl. G10L 15/04; G10L 15/16

(52) U.S. Cl. CPC G10L 15/04; G10L 15/16

(57) ABSTRACT

A speech separation device according to an embodiment of the present disclosure may include a generating unit, an output unit, and a mask unit. The generating unit may provide a channel feature generated based on an input feature corresponding to an input from each of a plurality of microphones. The output unit may perform spatial modeling for a time axis and a frequency axis based on the channel feature and provide an output feature. The mask unit may generate a mask based on the output feature. The speech separation device may improve speech separation performance by filtering input features using a mask derived from output features generated through spatial modeling for the time and frequency axes.

### CROSS-REFERENCE TO RELATED APPLICATION(S)

This application claims benefit of priority to Korean Patent Application No. 10-2025-0043969 filed on Apr. 4, 2025 in the Korean Intellectual Property Office, the disclosure of which is incorporated herein by reference in its entirety.

### BACKGROUND

### 1. Field

The present disclosure relates to a speech separation device.

### 2. Description of Related Art

Existing multi-channel speech separation methods have had difficulties in effectively modeling spatial and speech information separately. Recently, various studies have been conducted to address this issue.

### RELATED ART DOCUMENT

### [Patent Document]

Korean Patent No. 10-2590887 (registered on Oct. 13, 2023)

### SUMMARY

An aspect of the present disclosure may provide a speech separation device capable of improving speech separation performance by filtering input features using a mask derived from output features generated through spatial modeling for the time and frequency axes.

A speech separation device according to an embodiment of the present disclosure may include a generating unit, an output unit, and a mask unit. The generating unit may provide a channel feature generated based on an input feature corresponding to an input from each of a plurality of microphones. The output unit may perform spatial modeling for a time axis and a frequency axis based on the channel feature and provide an output feature. The mask unit may generate a mask based on the output feature.

The generating unit may include a correlation unit and a convolution unit. The correlation unit may perform a correlation operation on the input features respectively corresponding to the plurality of microphones to provide a correlation feature. The convolution unit may perform a convolution on the correlation feature to provide the channel feature.

The output unit may include a first transformer and a second transformer. The first transformer may provide a frequency-axis modeling feature calculated by dividing the channel feature by time. The second transformer may provide a time axis modeling feature calculated by dividing the frequency-axis modeling feature by frequency.

The output unit may provide the output feature by alternately and repeatedly operating the first transformer and the second transformer.

The first transformer may include a first local transformer and a first global transformer. The first local transformer may perform calculation based on a portion of a frequency domain of the channel feature divided by time. The first global transformer may perform calculation based on the entire frequency domain of the channel feature divided by time.

The second transformer may include a second local transformer and a second global transformer. The second local transformer may perform calculation based on a portion of a time domain of the frequency-axis modeling feature divided by frequency. The second global transformer may perform calculation based on the entire time domain of the frequency-axis modeling feature divided by frequency.

The above mask unit may include a mask generating unit. The Mask generating unit may convolve the output feature to generate the mask for each speaker.

The speech separation device may further include a filter unit. The filter unit may filter the input feature with the mask to provide an output signal for each speaker.

The speech separation device may further include a correction unit. The correction unit may correct the output signal to provide a final signal for each speaker.

The correction unit may further include a beamforming unit and a signal enhancement unit. The beamforming unit may beamform the output signal for each speaker and may provide a beamforming signal. The signal enhancement unit may provide the final signal for each speaker based on the beamforming signal and the input feature.

A speech separation system according to another embodiment of the present disclosure may include a generating unit, a output unit, a mask unit, and a filter unit. The generating unit may provide a channel feature generated based on an input feature corresponding to an input of each of a plurality of microphones. The output unit may perform spatial modeling for a time axis and a frequency axis based on the channel feature and provide an output feature. The mask unit may generate a mask based on the output feature. The filter unit may filter the input feature using the mask and provide an output signal for each speaker.

The generating unit may include a correlation unit and a convolution unit. The correlation unit may perform a correlation operation on the input features respectively corresponding to the plurality of microphones to provide a correlation feature. The convolution unit may perform a convolution on the correlation feature to provide the channel feature.

In an operating method of a speech separation device according to another embodiment of the present disclosure, a generating unit may provide a channel feature generated based on an input feature corresponding to an input of each of a plurality of microphones. An output unit may perform spatial modeling for a time axis and a frequency axis based on the channel features to provide an output feature. The mask unit may generate a mask based on the output feature.

In an operating method of a speech separation system according to another embodiment of the present disclosure, a generating unit may provide a channel feature generated based on an input feature corresponding to an input of each of a plurality of microphones. An output unit may perform spatial modeling for a time axis and a frequency axis based on the channel features to provide an output feature. The mask unit may generate a mask based on the output feature. A filter unit may filter the input feature using the mask to provide an output signal for each speaker.

### BRIEF DESCRIPTION OF DRAWINGS

FIG. 1 is a diagram illustrating a speech separation device according to embodiments of the present disclosure.

FIG. 2 is a diagram illustrating a generating unit included in the speech separation device of FIG. 1.

FIGS. 3 and 4 are diagrams illustrating an operation of the generating unit included in the speech separation device of FIG. 1.

FIG. 5 is a diagram illustrating an output unit included in the speech separation device of FIG. 1.

FIGS. 6 and 7 are diagrams illustrating an operation of the output unit included in the speech separation device of FIG. 1.

FIG. 8 is a diagram illustrating a first transformer included in the speech separation device of FIG. 1.

FIG. 9 is a diagram illustrating a second transformer included in the speech separation device of FIG. 1.

FIG. 10 is a diagram illustrating a mask unit included in the speech separation device of FIG. 1.

FIG. 11 is a diagram illustrating an operation of the mask unit included in the speech separation device of FIG. 1.

FIG. 12 is a diagram illustrating a filter unit and a correction unit included in the speech separation device of FIG. 1.

FIG. 13 is a diagram illustrating an example of a correction unit included in the speech separation device of FIG. 1.

FIG. 14 is a diagram illustrating a speech separation system according to embodiments of the present disclosure.

FIG. 15 is a flowchart illustrating an operating method of a speech separation device according to embodiments of the present disclosure.

FIG. 16 is a flowchart illustrating an operating method of a speech separation system according to embodiments of the present disclosure.

### DETAILED DESCRIPTION

In the specification, in adding reference numerals to components throughout the drawings, it is to be noted that like reference numerals designate like components even though components are shown in different drawings.

Meanwhile, meanings of the terms described in this specification should be understood as follows.

Terms of singular forms used herein are intended to include their plural forms unless explicitly indicated otherwise, and a scope of the present disclosure is not limited by the terms used herein.

It is to be understood that a term “include” or “have” does not preclude the presence or addition of one or more other features, numerals, operations, components, parts or combinations thereof, which is mentioned in the specification.

Hereinafter, embodiments of the present disclosure are described in detail with reference to the accompanying drawings.

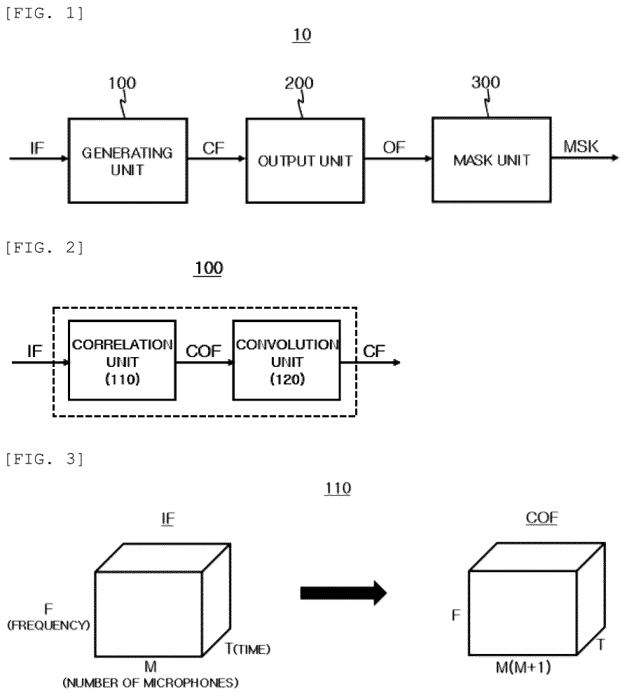

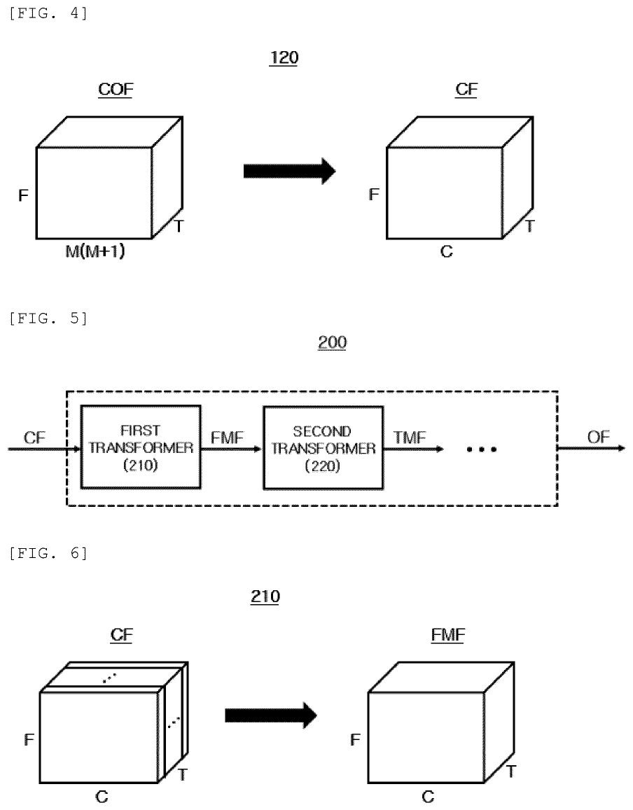

FIG. 1 is a diagram illustrating a speech separation device according to embodiments of the present disclosure, FIG. 2 is a diagram illustrating a generating unit included in the speech separation device of FIG. 1, and FIGS. 3 and 4 are diagrams illustrating an operation of the generating unit included in the speech separation device of FIG. 1.

Referring to FIGS. 1 to 4, a speech separation device 10 according to an embodiment of the present disclosure may include a generating unit 100, an output unit 200, and a mask unit 300.

The generating unit 100 may provide a channel feature CF generated based on an input feature IF corresponding to an input from each of a plurality of microphones. For example, the number of microphones may be M, and signals input to each of the M microphones may be expressed in the form of a matrix distinguished by time T and frequency F. In this case, the M matrices distinguished by time T and frequency F may be the input feature IF illustrated in FIG. 3.

In an embodiment, the generating unit 100 may include a correlation unit 110 and a convolution unit 120. The correlation unit 110 may perform a correlation operation on the input features IF corresponding to each of the plurality of microphones to provide a correlation feature COF. For example, the correlation unit 110 may perform a correlation operation on each of the M matrices to produce the correlation feature COF expressed with M (M+1) matrices.

For example, the correlation feature COF may be calculated as shown in Equation 1 below.

$${z}_{tf} = {[ ℜ ( {X}_{tfm} {X}_{{tfm}^{′}}^{*} ) 𝔍 ( {X}_{tfm} {X}_{{tfm}^{′}}^{*} ) ]}_{1 \leq m \leq {m}^{′} \leq M} ∈ {ℝ}^{M ( M + 1 )} \qquad [ Equation 1 ]$$

Here, z_{tf} may be the correlation feature COF, t may be a frame index, f may be a frequency index, m and m′ may be microphone indices, X_{tfm} may be the input feature IF, [symbol] may be a real part operator, and [symbol] may be an imaginary part operator.

In addition, the correlation feature COF may be calculated as shown in Equation 2 below for stable learning.

$${z}_{tf} = {[ ℜ ( \frac{{X}_{tfm} {X}_{{tfm}^{′}}^{*}}{{\vert {X}_{tfm} {X}_{{tfm}^{′}}^{*} \vert}^{β}} ) 𝔍 ( \frac{{X}_{tfm} {X}_{{tfm}^{′}}^{*}}{{\vert {X}_{tfm} {X}_{{tfm}^{′}}^{*} \vert}^{β}} ) ]}_{1 \leq m \leq {m}^{′} \leq M} ∈ {ℝ}^{M ( M + 1 )} \qquad [ Equation 2 ]$$

Here, z_{tf} may be the correlation feature COF, t may be the frame index, f may be the frequency index, m and m′ may be microphone indices, X_{tfm} may be the input feature IF, [symbol] may be the real part operator, [symbol] may be the imaginary part operator, and β may be a real value between 0 and 1.

The convolution unit 120 may perform convolution on the correlation feature COF to provide a channel feature CF. For example, the convolution unit 120 may perform a 2D convolution or linear layer operation on the correlation feature COF to produce the channel feature CF, as illustrated in FIG. 4.

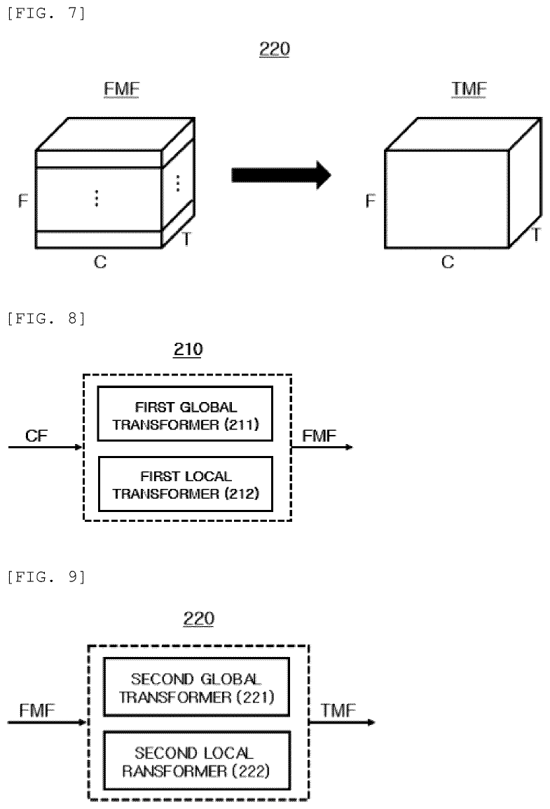

FIG. 5 is a diagram illustrating an output unit included in the speech separation device of FIG. 1, and FIGS. 6 and 7 are diagrams illustrating an operation of the output unit included in the speech separation device of FIG. 1.

Referring to FIGS. 1 to 7, the output unit 200 may perform spatial modeling for the time and frequency axes based on the channel feature CF to provide an output feature OF.

In an embodiment, the output unit 200 may include a first transformer 210 and a second transformer 220. The first transformer 210 may provide a frequency axis modeling feature FMF calculated by dividing the channel feature CF by time T. For example, a plurality of times T may include a first time to a T-th time, and the channel feature CF may be divided into the first time to the T-th time along the time axis. In this case, the first transformer 210 may calculate the channel feature CF divided into the first time to the T-th time along the time axis to provide a frequency axis modeling feature FMF.

The second transformer 220 may provide a time axis modeling feature TMF calculated by dividing the frequency-axis modeling feature FMF by frequency F. For example, the plurality of frequencies F may include a first frequency to an F-th frequency, and the frequency axis modeling feature FMF may be divided into the first frequency to the F-th frequency along the frequency axis. In this case, the second transformer 220 may calculate the frequency axis modeling feature FMF divided into the first frequency to the F-th frequency along the frequency axis to provide a time axis modeling feature TMF.

In an embodiment, the output unit 200 may provide an output feature OF by alternately and repeatedly operating the first transformer 210 and the second transformer 220. For example, the time axis modeling feature TMF output from the second transformer 220 may be provided as an input of a 1_1 transformer cascaded with the second transformer 220, and the 1_1 transformer may perform the same operation as that of the first transformer 210 to provide the 1_1 frequency-axis modeling feature. Thereafter, the 1_1 frequency-axis modeling feature may be provided as an input of a 2_1 transformer cascaded with the 1_1 transformer, and the 2_1 transformer may perform the same operation as that of the second transformer 220 to provide the 2_1 time axis modeling feature TMF. Here, the output unit 200 may provide the time axis modeling feature TMF and frequency-axis modeling feature FMF generated by repeating the above operations as the output feature OF.

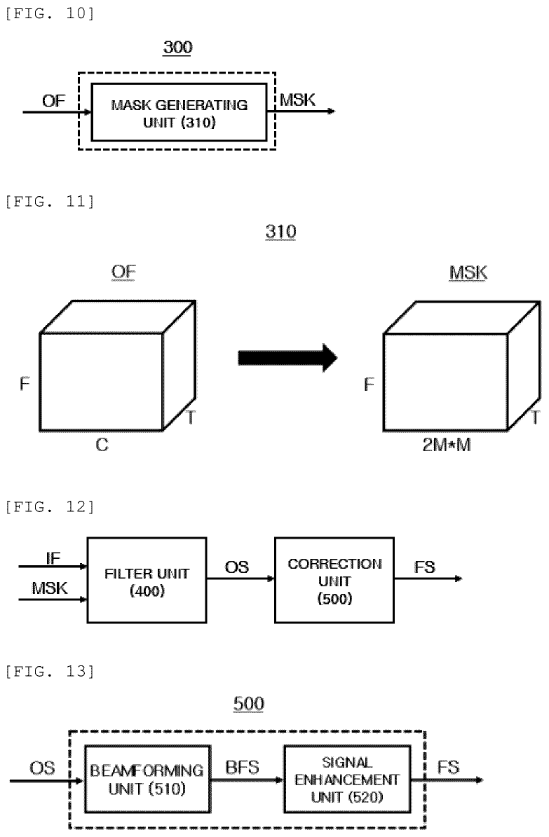

FIG. 8 is a diagram illustrating a first transformer included in the speech separation device of FIG. 1, and FIG. 9 is a diagram illustrating a second transformer included in the speech separation device of FIG. 1.

Referring to FIGS. 1 to 9, in an embodiment, the first transformer 210 may include a first local transformer 212 and a first global transformer 211.

The first local transformer 212 may perform calculation based on a portion of a frequency domain of the channel feature CF divided by time T, and the first global transformer 211 may perform calculation based on the entire frequency domain of the channel feature CF divided by time T. For example, a plurality of frequencies F may include a first frequency to an F-th frequency, and the first local transformer 212 may perform a transformer operation using only some of the first frequency to the F-th frequency. The first global transformer 211 may perform a transformer operation using the entire frequency corresponding to the first frequency to the F-th frequency.

In an embodiment, the second transformer 220 may include a second local transformer 222 and a second global transformer 221.

The second local transformer 222 may perform calculation based on a portion of a time domain of the frequency-axis modeling feature FMF divided by frequency F. The second global transformer 221 may perform calculation based on the entire time domain of the frequency-axis modeling feature FMF divided by frequency F. For example, the a plurality of times T may include a first time through a T-th time, and the second local transformer 222 may perform a transformer operation using a portion of the first time through the T-th time. The second global transformer 221 may perform a transformer operation using the entire time corresponding to the first time to the T-th time.

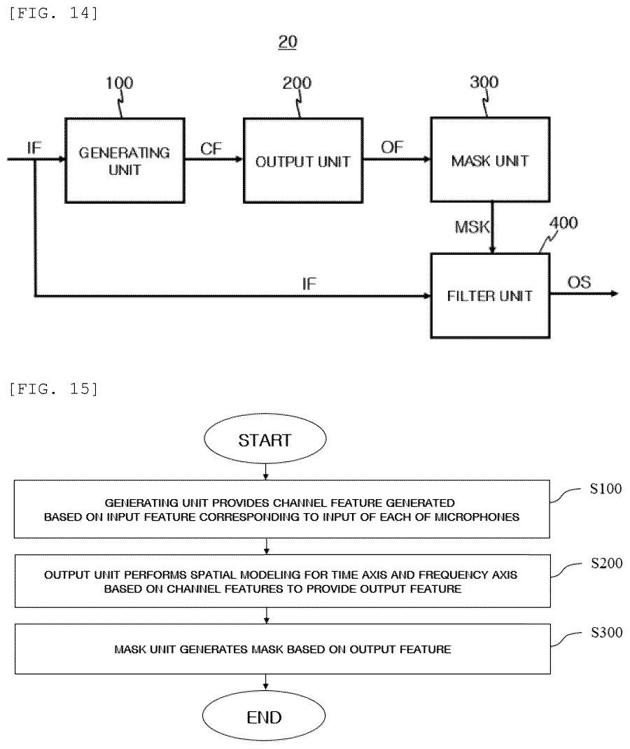

FIG. 10 is a diagram illustrating a mask unit included in the speech separation device of FIG. 1, FIG. 11 is a diagram illustrating an operation of the mask unit included in the speech separation device of FIG. 1, FIG. 12 is a diagram illustrating a filter unit and a correction unit included in the speech separation device of FIG. 1, and FIG. 13 is a diagram illustrating an example of a correction unit included in the speech separation device of FIG. 1.

Referring to FIGS. 1 to 13, the mask unit may generate a mask MSK based on the output feature OF.

In an embodiment, the mask unit 300 may include a mask generating unit 310. The mask generating unit 310 may convolve the output feature OF to generate up to K masks MSK for each speaker. For example, the mask generating unit 310 may perform a 2D convolution or linear layer operation on the output feature OF to generate K masks MSK.

In an embodiment, the mask unit 300 may generate as many masks MSK as the number of microphones M respectively corresponding to K speakers. For example, the mask generating unit 310 may perform a 2D convolution or linear layer operation on the output feature OF to generate M*K masks MSK.

In an embodiment, the speech separation device 10 may further include a filter unit 400. The filter unit 400 may filter the input feature IF with the mask MSK to provide an output signal OS for each speaker.

For example, the output signal OS may be calculated as shown in Equation 3 below.

$${Y}_{k , tf} = {w}_{k , tf} {\overline{x}}_{tf} ∈ ℂ \qquad [ Equation 3 ]$$

Here, Y_{k,tf} may be the output signal for each speaker, x̅_{tf} may be a multi-channel multi-tap input feature, W_{k,tf}∈ [symbol] ^{1x×(2L+1)M} may be the mask (MSK), k may be a speaker index, t may be a frame index, f may be a frequency index, and 2L+1 may be the number of taps.

Meanwhile, a multi-tap input feature may be calculated as shown in Equation 3-1 below using the input feature (IF).

$${\overline{x}}_{tf} = {[ {x}_{t - Lf}^{T} , … , {x}_{tf}^{T} , … , {x}_{t + Lf}^{T} ]}^{T} ∈ {ℂ}^{( 2 L + 1 ) M} \qquad [ Equation 3 - 1 ]$$

Here, x̅_{tf} may be the multi-channel multi-tap input feature, and x_{tf}=[X_{tf1}, . . . , X_{tfM}]^{T}∈ [symbol] ^{M} may be a multi-channel input feature.

In addition, the output signal OS may be calculated as shown in Equation 4 below to provide a multi-channel signal for each speaker.

$${y}_{k , tf} = {W}_{k , tf} {\overline{x}}_{tf} ∈ {ℂ}^{M} \qquad [ Equation 4 ]$$

Here, y_{k,tf}=[Y_{k,tf1}, . . . , Y_{k,tfM}]^{T} may be a multi-channel output signal for each speaker, x̅_{tf}=[x_{t-Lf}^{T}, . . . , x_{tf}^{T}, . . . , x_{t+Lf}^{T}]^{T} may be the multi-channel multi-tap input feature (IF), W_{k,tf}∈ [symbol] ^{M×(2L+1)M} may be M masks MSK for each speaker, k may be the speaker index, t may be the frame index, f may be the frequency index, and 2L+1 may be the number of taps.

In an embodiment, the speech separation device 10 may further include a correction unit 500. The correction unit 500 may correct the output signal OS to provide a final signal FS for each speaker.

In another embodiment, the correction unit 500 may further include a beamforming unit 510 and a signal enhancement unit 520. The beamforming unit 510 may beamform an output signal for each speaker to provide a beamforming signal BFS. The signal enhancement unit 520 may provide final signal FS for each speaker based on the beamforming signal BFS and the input feature IF. For example, the signal enhancement unit 520 may further perform the operations of the generating unit 100, the output unit 200, the mask unit 300, and the filter unit 400 described with reference to FIGS. 1 to 13 based on the beamforming signal BFS and input feature IF to separate speech of individual speakers with higher performance, thereby providing the final signal FS.

The speech separation device 10 according to the present disclosure may improve speech separation performance by filtering the input feature IF using the mask MSK derived based on the output feature OF generated through spatial modeling for the time and frequency axes.

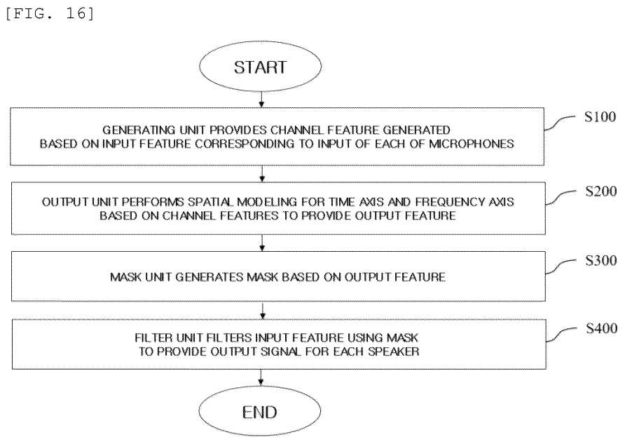

FIG. 14 is a diagram illustrating a speech separation system according to embodiments of the present disclosure.

Referring to FIGS. 1 to 14, a speech separation system 20 according to an embodiment of the present disclosure may include the generating unit 100, the output unit 200, the mask unit 300, and the filter unit 400. The generating unit 100 may provide the channel feature CF generated based on the input feature IF corresponding to an input of each of a plurality of microphones. The output unit 200 may perform spatial modeling for the time and frequency axes based on the channel feature CF to provide the output feature OF. The mask unit 300 may generate the mask MSK based on the output feature OF. The filter unit 400 may filter the input feature IF with the mask MSK to provide the output signal OS for each speaker.

In an embodiment, the generating unit 100 may include the correlation unit 110 and the convolution unit 120. The correlation unit 110 may perform a correlation operation on the input features IF respectively corresponding to the plurality of microphones to provide the correlation feature COF. The convolution unit 120 may perform a convolution on the correlation feature COF to provide the channel feature CF.

FIG. 15 is a flowchart illustrating an operating method of a speech separation device according to embodiments of the present disclosure.

Referring to FIGS. 1 to 15, in the operating method of the speech separation device 10 according to embodiments of the present disclosure, the generating unit 100 may provide the channel feature CF generated based on the input feature IF corresponding to an input from each of a plurality of microphones (S100). The output unit 200 may perform spatial modeling on the time and frequency axes based on the channel feature CF to provide the output feature OF (S200). The mask unit 300 may generate the mask MSK based on the output feature OF (S300). In the operating method of the speech separation device 10 according to the present disclosure, speech separation performance may be improved by filtering the input feature IF using the mask MSK derived based on the output feature OF generated through spatial modeling for the time and frequency axes.

FIG. 16 is a flowchart illustrating an operating method of the speech separation system according to embodiments of the present disclosure.

Referring to FIGS. 1 to 16, in the operating method of the speech separation system 20 according to an embodiment of the present disclosure, the generating unit 100 may provide the channel feature CF generated based on the input feature IF corresponding to an input from each of the a plurality of microphones (S100). The output unit 200 may perform spatial modeling for the time and frequency axes based on the channel feature CF to provide the output feature OF (S200). The mask unit 300 may generate the mask MSK based on the output feature OF (S300). The filter unit 400 may filter the input feature IF using the mask MSK to provide the output signal OS for each speaker (S400).

The present disclosure, as described above, has the following effects.

The speech separation device according to the present disclosure may improve speech separation performance by filtering the input feature using the mask derived based on the output feature generated through spatial modeling for the time and frequency axes.

In addition, other features and advantages of the present disclosure may be newly recognized through the embodiments of the present disclosure.

In addition to the above-mentioned technical tasks of the present disclosure, other features and advantages of the present disclosure may be described below, or may be clearly understood by those skilled in the art to which the present disclosure pertains from such description and explanation.

What is claimed is:

1. A speech separation device comprising:
a generating unit providing a channel feature generated based on an input feature corresponding to an input from each of a plurality of microphones;
an output unit performing spatial modeling for a time axis and a frequency axis based on the channel feature and providing an output feature; and
a mask unit generating a mask based on the output feature.

2. The speech separation device of claim 1, wherein
the generating unit includes:
a correlation unit performing a correlation operation on the input features respectively corresponding to the plurality of microphones to provide a correlation feature; and
a convolution unit performing a convolution on the correlation feature to provide the channel feature.

3. The speech separation device of claim 2, wherein
the output unit includes:
a first transformer providing a frequency-axis modeling feature calculated by dividing the channel feature by time; and
a second transformer providing a time axis modeling feature calculated by dividing the frequency-axis modeling feature by frequency.

4. The speech separation device of claim 3, wherein the output unit provides the output feature by alternately and repeatedly operating the first transformer and the second transformer.

5. The speech separation device of claim 4, wherein
the first transformer includes:
a first local transformer performing calculation based on a portion of a frequency domain of the channel feature divided by time; and
a first global transformer performing calculation based on the entire frequency domain of the channel feature divided by time.

6. The speech separation device of claim 5, wherein
the second transformer includes:
a second local transformer performing calculation based on a portion of a time domain of the frequency-axis modeling feature divided by frequency; and
a second global transformer performing calculation based on the entire time domain of the frequency-axis modeling feature divided by frequency.

7. The speech separation device of claim 6, wherein the mask unit includes a mask generating unit convolving the output feature to generate the mask for each speaker.

8. The speech separation device of claim 7, further comprising a filter unit filtering the input feature with the mask to provide an output signal for each speaker.

9. The speech separation device of claim 8, further comprising a correction unit correcting the output signal to provide a final signal for each speaker.

10. The speech separation device of claim 9, wherein
the correction unit further includes:
a beamforming unit beamforming the output signal for each speaker and providing a beamforming signal; and
a signal enhancement unit providing the final signal for each speaker based on the beamforming signal and the input feature.

11. A speech separation system comprising:
a generating unit providing a channel feature generated based on an input feature corresponding to an input of each of a plurality of microphones;
an output unit performing spatial modeling for a time axis and a frequency axis based on the channel feature and providing an output feature;
a mask unit generating a mask based on the output feature; and
a filter unit filtering the input feature using the mask and providing an output signal for each speaker.

12. The speech separation system of claim 11, wherein
the generating unit includes:
a correlation unit performing a correlation operation on the input features respectively corresponding to the plurality of microphones to provide a correlation feature; and
a convolution unit performing a convolution on the correlation feature to provide the channel feature.

13. An operating method of a speech separation device, the operating method comprising:
providing, by a generating unit, a channel feature generated based on an input feature corresponding to an input of each of a plurality of microphones;
performing, by an output unit, spatial modeling for a time axis and a frequency axis based on the channel features to provide an output feature; and
generating, by a mask unit, a mask based on the output feature.

14. An operating method of a speech separation system, the operating method comprising:
providing, by a generating unit, a channel feature generated based on an input feature corresponding to an input of each of a plurality of microphones;
performing, by an output unit, spatial modeling for a time axis and a frequency axis based on the channel features to provide an output feature;
generating, by a mask unit, a mask based on the output feature; and
filtering, by a filter unit, the input feature using the mask to provide an output signal for each speaker.
